(19) United States
(12) Patent Application Publication
(10) Pub. No.: US 2011/0083067 A1
(43) Pub. Date: Apr. 7, 2011

(54) WEB BROWSING ENVIRONMENT PROVIDER SYSTEM FOR MULTIPLE USERS AND CONTROL METHOD THEREOF

(75) Inventor: Jae Bum Shim, Seoul (KR)

(73) Assignee: LOGICPLANT, Seoul (KR)

(21) Appl. No.: 12/988,014

(22) PCT Filed: Feb. 22, 2008
(86) PCT No.: PCT/KR08/01042

§ 371 Date: Oct. 15, 2010

(51) Int. Cl. G06F 17/00; G06F 3/00

(52) U.S. Cl. 715/200; 715/738

(57) ABSTRACT

Provided are a web browsing environment provider system for multiple users, in which a remote server computer is used, and a method of controlling the system. The system includes a user device on which a user interface is displayed for reading a web page and controlling web browsing, and a web browsing environment server efficiently generating and managing an independent web browsing environment for each respective user device, notifying the user device about a state of the independent web browsing environment, rendering a web page, executing active contents contained in the web page, transmitting a web page image that is rendered to the user device, and controlling an operation requested by the user device to operate in the web browsing environment, thereby saving on resources related to performance. Thus, multiple users can perform the same level of web browsing operation as in a personal computer (PC) that is a main device of web browsing by using a user device having lower performance than the PC or low compatibility with the PC.

### TECHNICAL FIELD

The present invention relates to a web browsing environment provider system for multiple users, in which multiple users can perform the same level of web browsing operation as in a personal computer (PC) that is a main device of web browsing by using a user device having lower performance than the PC or low compatibility with the PC, and a control method of the web browsing environment provider system for multiple users

### BACKGROUND ART

As wireless Internet has been widely used, user devices such as cellular phones have established as information terminals that can be used anywhere. Thus, user s requirements to use cellular phones for performing web browsing that is mainly performed via Internet have increased. To satisfy these user s requirements, software and mobile communication fields have created the terminology full browsing that performed in a cellular phone so as to have the same level of web browsing operation as in a personal computer (PC), and research has been conducted on an environment for executing the full browsing.

However, the following problems arise from the full browsing executed in cellular phones. That is, since web pages are assumed to be displayed and be operated in a device having a similar level of performance to a PC when the web pages are created, it is difficult to display the web pages on a cellular phone having lower performance than that of the PC. For example, although the web pages exhibit complicated images varying at high speed by flash and dynamic layout, the performance of a cellular phone is insufficient to appropriately display these images, and it is difficult for the cellular phone to render and construct theses images.

The web pages include elements such as flash contents or java script that is not affected by the operating system (OS) or central processing unit (CPU) in which the web pages are processed. In addition, the web pages also include elements such as an ActiveX control that can operate in only specific OS and CPU (e.g., in the case of the Active X control, the Active X control can operate in Microsoft windows as an OS, and Intel x86 or a compatible device therewith as a CPU). Thus, a cellular phone that is not compatible with PCs in terms of the OS and CPU cannot display and use the elements such as ActiveX control. To overcome this problem, a method of copying and embodying a PC environment in a cellular phone may be considered, but this method has no practical use due to the low performance of the cellular phone. In addition, an intermediate server may construct an environment in which the elements such as ActiveX control can be executed, but it may be difficult to connect the elements to other contents that are rendered by the cellular phone.

To overcome the above problems, there is a need for a system including a server compatible with a PC and having higher performance than the PC, and a user device performing a function that is not related to compatibility and does not require high performance, wherein the sever performs web browsing, and the user device provides only an interface for reading a web page and controlling the web browsing. To achieve this, since a single server needs to support various users web browsing operations, there is a need to efficiently perfume the web browsing operations.

### DISCLOSURE OF INVENTION

### Technical Problem

The present invention provides a web browsing environment provider system for multiple users, in which multiple users can perform the same level of web browsing operation as in a personal computer (PC) that is a main device of web browsing by using a user device having lower performance than the PC or low compatibility with the PC, and a control method of the web browsing environment provider system for multiple users.

### Technical Solution

According to an aspect of the present invention, there is provided a web browsing environment provider system for multiple users, the system including at least one user device on which a user interface is displayed for reading a web page and controlling web browsing; and a web browsing environment server connected to the user device through a network, generating and managing an independent web browsing environment for each respective user device, notifying the user device about a state of the independent web browsing environment, rendering a web page, executing active contents contained in the web page, transmitting a web page image that is rendered to the user device, and controlling an operation requested by the user device to operate in the web browsing environment.

According to another aspect of the present invention, there is provided a method of controlling a web browsing environment provider system for multiple users, wherein the system includes at least one user device connected and a web browsing environment server, which are connected via a network and communicates with each other, the method including generating a web browsing environment for each respective user device to the web browsing environment server; displaying a user interface for the web browsing environment on the user device, searching the user interface on the user device, and transmitting a function item selected by searching the user interface to the web browsing environment server; controlling a web browser unit in the web browsing environment server so that an operation corresponding to the selected function item is performed, wherein the web browser unit performs the selected function item; and detecting a change in a state of the web browser unit and notifying the user device about information regarding the detected changed through a network.

In order to accomplish the above object, the present invention provides a computer-readable recording medium in which a program for executing the method in a computer is recorded.

### ADVANTAGEOUS EFFECTS

According to the present invention, a web browsing operation is performed by a web browsing environment server having the same or higher performance compared to a personal computer (PC) and perfect compatibility with the PC. When multiple users perform web browsing operations by using a single web browsing environment server, a user can have the respective web browsing environment that is independent upon another user, and as many as possible users can perform web browsing operations in the single web browsing environment server. Thus, multiple users using user devices having lower performance than the PC or low compatibility with the PC can perform the same level of web browsing operations as in a PC that is a main device of web browsing by using a single browsing environment server.

### BRIEF DESCRIPTION OF DRAWINGS

FIG. 1 is a diagram for explaining a web browsing environment provider system for multiple users, according to an embodiment of the present invention;

FIG. 2 is a block diagram for explaining a web browsing environment server of FIG. 1, according to an embodiment of the present invention; and

FIGS. 3 and 4 are message sequence charts for explaining a method of controlling a web browsing environment provider system for multiple users, in which a remote server computer is used, according to an embodiment of the present invention.

### BEST MODE FOR CARRYING OUT THE INVENTION

Hereinafter, the present invention will be described in detail by explaining exemplary embodiments of the invention with reference to the attached drawings.

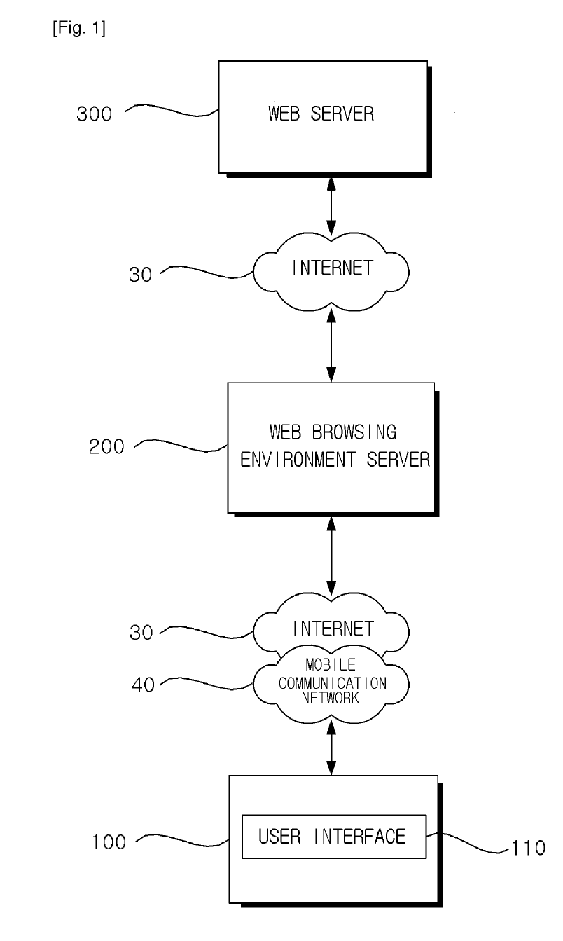

FIG. 1 is a diagram for explaining a web browsing environment provider system for multiple users, according to an embodiment of the present invention. Referring to FIG. 1, the system according to the present embodiment includes a web server 300, a web browsing environment server 200 connected to and communicated with the web server 300 via Internet 30, and a user device 100 connected to and communicated with the web browsing environment server 200 via Internet 30 and a mobile communication network 40.

The web browsing environment server 200 performs a web browsing function. The web browsing environment server 200 may be installed in a company providing a web browsing environment service for multiple users. The user device 100 displays a web page transmitted from the web browsing environment server 200 on a screen of the user device 100, and receives a user s control input. Since the user device 100 and the web browsing environment server 200 separately perform the respective functions, the user device 100 may freely perform operations regardless of its performance and compatibility. Thus, even if the user device 100 has lower performance than that of a personal computer (PC) and low compatibility with the PC, the user device 100 may perform the same level of web browsing as in the PC. Examples of the user device 100 include a cellular phone, a smart phone, a notebook computer, a terminal for digital broadcasting, a personal digital assistant (PDA), a portable multimedia player (PMP), a navigation apparatus, or the like.

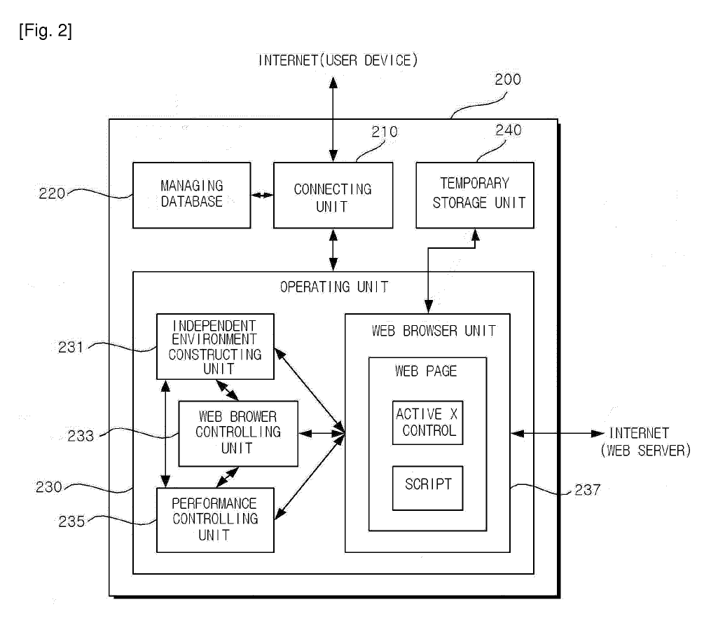

FIG. 2 is a block diagram for explaining the web browsing environment server 200 of FIG. 1, according to an embodiment of the present invention. Referring to FIG. 2, the web browsing environment server 200 includes a connecting unit 210, a managing database 220, an operating unit 230, and a temporary storage unit 240. The connecting unit 210 performs user authentication by using the managing database 220 when the user device 100 is connected to the connecting unit 210 via a network, and manages the operating unit 230 to operate for each respective user. Information for user authentication is stored in the form of database in the managing database 220.

The operating unit 230 performs a separate process in an operation system (OS) for each respective user and interacts with the user device 100 via the network. The operating unit 230 includes an independent environment constructing unit 231, a web browser controlling unit 233, a performance controlling unit 235 and a web browser unit 237. When the operating unit 230 is connected to the user device 100 via the network, the independent environment constructing unit 231 may construct a web browsing environment independent upon other operating units connected to other user devices so that each user may use his or her own web browsing environment.

The web browser controlling unit 233 receives a command from the user device 100, and controls the web browser unit 237 so as to perform web browsing. In addition, the web browser controlling unit 233 detects a change in a state of the web browser unit 237, and transmits a result of detection to the user device 100. The web browser controlling unit 233 transmits a web page image rendered by the web browser unit 237 to the user device 100 so that the web page image is displayed on a screen of a user interface 110. The performance controlling unit 235 may control an operation of the web browser unit 237 so as to save on resources related to performance of the web browsing environment server 200. Thus, as many as possible user devices may be connected to a single web browsing environment server 200 to perform web browsing operations. The web browser unit 237 actually performs the web browsing, renders the web page, and executes ActiveX control and script contained in the web page, according to the control of the web browser controlling unit 233

The user device 100 is connected to the web browsing environment server 200 via the network to receive a web browsing service. The user device 100 displays, on the user interface 110, at least one of a web page image transmitted from the web browsing environment server 200, a menu for controlling the web browsing, and a common menu for controlling an entire web browsing environment, receives a user's input, and transmits the user's input to the web browsing environment server 200.

In the above-described structure, a method of constructing an independent web browsing environment for each respective user, which is performed by the independent environment constructing unit 231 of the operating unit 230, and a method of controlling an operation of the web browser unit 237 to save on resources related to performance of the web browsing environment server 200 will now be described, in more detail.

The method of constructing the independent web browsing environment for each respective user is determined according to how the web browser unit 237 performs the web browsing. Methods of performing the web browsing in the web browser unit 237 include two methods. In a first method of these methods, the web browsing may be performed by web browser control provided by Microsoft windows OS itself. In this method, an actual web browsing function is provided by the web browser control of a windows OS. The web browser unit 237 calls an interface function of the web browser control, transmits a window message via the independent environment constructing unit 231, transmits a command by using key board and mouse simulations, and receives a change in a state of the web browser control. This method has advantages as follows. Due to the use of the web browser control performing the actual web browsing function of Internet explorer that is the most widely used in the world, the highest compatibility for processing a web page can be achieved, and it is not required to embody a separate web browser that is complicated software. On the other hand, it is difficult for the performance controlling unit 235 to completely control the performance of the web browser unit 237, in consideration of interface limitations in which the web browser control is exposed out of the performance controlling unit 235.

In a second method of these methods, the web browsing function together with a script operator is executed by the web browser unit 237 itself. This method has opposite advantages and disadvantages to the first method.

The independent web browsing environment for each respective user, which is constructed by the independent environment constructing unit 231, refers to an environment configured so that a user may independently logon to the web browsing environment server 200 to execute a web browser on a windows desktop independent upon another user, a web page processed by the web browser and active elements such as ActiveX control executed in the web page may be displayed on an actual screen, and the user may recognize as if he or she directly controls the web browser.

Generally, methods of providing an independent web browsing environment for each respective user may include the following three methods. In a first method of these methods, the web browsing environment server 200 generates actual accounts having the same number as the number of users, and the users performs logon to the user device 100 by using a corresponding account. In this method, additional load due to separate windows sessions and desktops are generated whenever the users perform logon to the user device 100, and the user device 100 needs to support a remote logon protocol defined by an OS. Thus, it is complicated to embody this method, and the performance of the user device 100 may be insufficient.

In a second method of these methods, a user actually uses a single PC by remote control by having one to one correspondence between the web browsing environment server 200 and the user device 100. In this method, since the user device 100 uses a single server, the number of servers is required as much as by the number of user devices, and thus it is impossible to construct a multiple-users environment.

A third method of these methods is almost the same as the second method. However, in the third method, a user recognizes as if the user uses a PC under the same environment as in the second method by constructing virtual machines in the web browsing environment server 200, without correspondence with an actual server. In the first and third methods, since the user may share and use a single server, without controlling any performance, resources related performance may be incurred. Thus, many users cannot connect to the web browsing environment server 200, and the license costs for the OS of the web browsing environment server 200 may increase due to the large numbers of accounts or OSs. In the third method, although the multiple-users environment may be constructed, a significant amount of resources related to performance of the web browsing environment server 200 needs to be used to drive the virtual machine having the same form including an OS installed therein in the web browsing environment server 200, the satisfactory number of users cannot be simultaneously admitted in terms of the performance of the web browsing environment server 200. In addition, since it is difficult to embody the virtual machine without purchasing conventional software, the virtual machine is embodied at a very high cost. Thus, the above-described three methods have no practical use due to the respective serious disadvantages.

Thus, in order to construct a useful environment that does not have the above-described problems, the web browsing environment server 200 constructs the following environment. First, windows XP or OS compatible therewith is used as an OS of the web browsing environment server 200. Second, all users use a single OS user account, the user account is already logged-on when a service starts, and a common windows desktop image is provided to the all users. Third, the operating unit 230 operates a separate process for each respective user on the common windows desktop image of the single OS user account, and thus a single image is shared by users. Also, a keyboard and a mouse are shared by the users. Fourth, the independent environment constructing unit 231 hooks a main windows API and internally performs a process on a process-by-process basis of the operating unit 230, generates a predetermined window message, and appropriately changes internal information according to the contents of the window message when the window message is dispatched so that the users may recognize as if each operating unit has independent mouse and keyboard on a process-by-process basis of the operating unit 230.

Fifth, when a web browser controlling unit captures an image of a web browser unit, the web browser controlling unit renders the image in an internal buffer by using a predetermined windows API with respect to a separate web browser window and a window related thereto, instead of capturing an actual windows desktop image like in conventional capture software, and thus the image may be captured without displaying the image on an actual screen. Thus, although web browser windows and windows related thereto, which are included in a plurality of operating units, overlap each other on the screen, the plurality of operating units may normally capture respective images. Sixth, when the web browser unit 237 performs web browsing by using a web browser control provided by a Micro windows OS, environment variables related to user folders are set for each respective operating unit, or the independent environment constructing unit 231 hooks a windows API related to reading and storing operations of files and internally processes the reading and storing operations, and thus cookies and temporary Internet files may be independently managed for each respective operating unit. By constructing this environment, each user may receive a web browsing environment independent from another user while using the minimum the resources related to performance of the web browsing environment server 200.

Next, a method of recognizing the independent environment constructing unit 231 to have independent mouse and keyboard states on a process-by-process basis of the operating unit 230 will now be described in more detail.

Reasons for hooking a windows API, generating a predetermined window message, and appropriately changing internal information according to the contents of the window message when the window message is dispatched will now be described. First, when the web browser unit 237 performs web browsing by using the web browser control provided by Microsoft windows OS, the web browser control recognizes mouse and keyboard states through the windows API and the dispatched window message. For example, when an image is rendered, the uppermost window based on a Z-order may be determined from among the current mouse cursor and corresponding mouse cursor by using window information related windows API (GetCursorPos, WindowFromPoint). When the uppermost window belongs to a user, the web browser control performs a special process such as highlighting of a hyperlink on a position where the current mouse cursor is located. Then, when the user moves the mouse cursor, the independent environment constructing unit 231 may recognize the movement of the mouse cursor through a mouse cursor movement (WM_MOUSEMOVE) message. Second, when a web browser is embodied in the web browsing environment server 200 itself, and an action of the web browser is processed by internal data exchange, since ActiveX controls contained in a web page are windows application programs that are manufactured by another company, the web browsing may also be performed through the windows API or the dispatched window message. Thus, when the web browser or the ActiveX controls receive information regarding the mouse and keyboard states directly from the OS, various operating units that simultaneously operate in a single windows desk top may receive common information. In addition, when the state of one operating unit changes, since the changed state affects other operating units, independent operations cannot be performed. Accordingly, independent states need to be maintained by hooking the windows API, generating a predetermined window message and changing internal information when the window message is dispatched.

In order to hook the windows API, a conventional DLL import table patch method or DLL function starting point instruction changing method may be used. In these methods, a specific process may be restricted to hook the windows API. This property is required to separately manage internal information on a process-by-process basis of the operating unit 230, which is performed in the independent environment constructing unit 231. Using these methods, windows API functions of DLL is replaced with internal functions to change and transmit information that is internally managed.

Exemplary windows APIs hooked to process mouse and keyboard information will now be described.
GetCursorPos: GetCursorPos returns the current position of a mouse cursor. The internal function returns a position of a virtual mouse cursor that is independently managed by each operation unit.
SetCursorPos: SetCursorPos sets the current position of a mouse cursor. The internal function sets a position of a virtual mouse cursor that is independently managed by each operating unit, without setting an actual position of a mouse cursor.
TrackMouseEvent: TrackMouseEvent receives information regarding that a mouse cursor goes in or out of a predetermined region through a window message. The internal function transmits information based on a position of a virtual mouse that is independently managed by each operating unit through the window message. In addition, in order to process information regarding mouse hover (which means that a mouse stays at a predetermined position for a predetermined period of time), a timer is internally used. If the position of the mouse cursor does not go out of the predetermined region until a predetermined period of time set in the timer elapses, a hover message is transmitted.
WindowFromPoint: WindowFromPoint returns the uppermost window based on a Z-order (which means an order in which windows accumulates on a screen) from among windows containing a predetermined point. The internal function selects the uppermost window from among windows belonging to the respective operating units so that this selection is not affected by the fact in that a window of another application program that is executed by another operating unit or server may be above windows of the current operating unit, based on a Z-order, in an actual environment.
GetKeyState: GetKeyState returns information regarding whether a predetermined key is held down. The internal function returns information based on an internal state managed according to key input information transmitted by a user device. Thus, when a predetermined key is held down in a user's operating unit, a corresponding key may not be held down in another user's operating unit.

By hooking the main windows API, a web browser and most of ActiveX controls may be controlled. If necessary, separate APIs performing a function related to the above APIs and extended functions may be hooked. Examples of the APIs may include GetCursorInfo, ChildWindowFromPoint, GetAsyncKeyState, SetKeyboardState, or the like.

Exemplary generated window messages will now be described.
WM_MOUSEMOVE: When a user device issues a command, or hooked SetCursorPos API moves a position of a mouse cursor, WM_MOUSEMOVE is generated to transmit a position of a mouse cursor, which is internally moved, to the uppermost window from among windows containing a predetermined point of the mouse cursor, based on a Z-order, that is, an order in which images accumulates.
WM_MOUSEHOVER, WM_MOUSELEAVE: WM_MOUSEHOVER, and WM_MOUSELEAVE are generated in order to manage a change in a position of a mouse cursor, which is requested by TrackMouseEvent.
WM_xBUTTONDOWN, WM_xBUTTONUP (x is one of L, R and M): When a user device requests mouse button click, WM_xBUTTONDOWN and WM_xBUTTONUP are transmitted to the uppermost window from among windows containing the internally current mouse cursor position based on a Z-order.
WM_KEYDOWN, WM_KEYUP, WM_CHAR: WM_KEYDOWN, WM_KEYUP, and WM_CHAR are generated in order to execute a keyboard input transmitted by a user device.

During dispatching the window message, internal information is appropriately changed according to the contents of the window message, in the following cases.
WM_xBUTTONDOWN, WM_xBUTTONUP (x is one of L, R and M): WM_xBUTTONDOWN and WM_xBUTTONUP update a state of a virtual key input, which is to be returned by GetKeyState windows API.
WM_KEYDOWN, WM_KEYUP: WM_KEYDOWN and WM_KEYUP update a state of a virtual key input, which is to be returned by a windows API.

With regard to keyboard focus that is one of key input states, a windows OS itself contains focus information for each respective thread. Thus, the keyboard focus has no problem in a normal case. However, when a manager provides a focus to a separate program by clicking an actual mouse, the focus contained in the windows OS for each respective thread of each operating unit may disappear, in consideration of operational properties of the windows OS. To overcome this problem, when the user device 100 issues a key board input command, an input function is restricted to a window containing a position of the current mouse cursor, the focus to the window of the position of the current mouse cursor is reset, and then a key input is performed. Alternatively, a mouse click message is transmitted to the corresponding window such that a corresponding window contains the focus, and then the key input is performed. Since a web browser or ActiveX controls almost never generate the key input, the problems related to the focus can be overcome by these methods.

The independent environment constructing unit 231 may hook windows API in order to manage cookies and Internet files for each respective operating unit 230. Examples of the windows API may include CreateFileA, CreateFileW, DeleteFileA, DeleteFileW, or the like. Internal functions replacing these functions may manage files through the respective paths by changing names of file paths of input parameters to the respective proper names of paths for each respective operating unit 230. In addition, in order to change an environment variable indicating a proper path of a windows user to a proper path for each respective operation unit 230, a predetermined method may be used. In the case of the web browser control provided by Microsoft windows OS itself, the cookies and the temporary Internet files may be managed through the proper path for each respective operating unit 230 by using this method.

The performance controlling unit 235 saves on resources related to performance of the web browsing environment server 200 by controlling image display and events of the web browser and ActiveX controls, and controlling all operating units so as not to perform a predetermined number of operations or more using a central processing unit (CPU) at a predetermined point of time.

When the performance controlling unit 235 controls the image display, window contents are prevented from being automatically rendered although the operating unit 230 is not needed by the web browser and ActiveX controls by positioning a web browser window on a windows desktop and then completely hiding a space above the web browser window with an empty window. This uses properties in that application programs do not render again window contents when the application programs windows are hidden on a screen. Instead, the web browser controlling unit 233 may capture a web page image without displaying the web page image on an actual screen by rendering the web page image in an internal buffer by using a predetermined windows API with respect to a separate web browser and a window related thereto, without capturing an actual windows desktop image. Thus, the web browser and ActiveX controls may render the window contents only at a point of time when the operating unit 230 needs to periodically transmit image contents to a user device. As a result, the performance controlling unit 235 may save on resources related to the performance used to render the window contents. Since a flash ActiveX control that is generally used in a web browser may render the window contents 10 times or more for one second, the significant amount of resources of performance may be saved according to a transmission period of the image contents of the operating unit 230.

The timer is a basic element required to continuously operate active elements contained in a web page, such as ActiveX control, script, or the like. The active elements are embodied so as not to be executed while occupying a CPU due to properties of the active elements, and to periodically operate when the active elements receive a corresponding timer event transmitted by the timer that is registered to work at a predetermined period. In the case of the ActiveX control or many scripts, since the timer is registered to work at a period of several tens to several hundreds of seconds, the number of operations of the ActiveX control or the many scripts is significantly large. In addition, the ActiveX control or the many scripts are executed regardless of whether the web page is displayed on a screen, and therefore a user sees the web page. In addition, in the case of exemplary Internet portal sites, since a single web page contains many flash ActiveX controls and scripts that works using a timer, a timer event is generated several tens to several hundreds of times every one second. Thus, the operations based on the timer event adversely affect the web browsing environment server 200 in terms of the performance when a single web browsing environment server 200 admits a plurality of users. Thus, the performance controlling unit 235 controls the resources related to performance of the web browsing environment server 200 by using the following method.

SetTimer and KillTimer windows API are hooked by using the same method as in the independent environment constructing unit 231, and registered timers are selectively stopped while being managed. The timer is stopped in two cases. First, when the user device 100 receives no input for a predetermined period of time, or a web page image is not displayed due to the configuration of the user interface 110 of the user device 100, all the timers are internally stopped. Thus, the active elements contained in the web page are stopped, and thus the resources related to performance of the web browsing environment server 200 may be significantly saved. Then, when the user device 100 receives an input again, or the web page image is displayed again, the timers work again, and thus the active elements contained in the web page may operate.

Second, when a user generate a new web page or converts a web page, and therefore a previous web page is not displayed, only the minimum number of active elements contained in the web page may operate for each respective user by selectively stopping only a timer generated from an active element contained in the previous web page. This method of selectively stopping the timer may be changed, and may be used or not, according to a method of embodying the web browser unit 237, that is, according to whether to recognize a web page requesting SetTimer and KillTimer. In the case where the web browser unit 237 is embodied using a web browser control provided by Microsoft windows Os itself, only when web pages are configured so as to operate in respective threads, the timer may be selectively stopped. This is because, when SetTimer and KillTimer are requested, a thread requesting SetTimer and KillTimer may be recognized, but a web browser requesting SetTimer and KillTimer may not be recognized. On the other hand, when a script operating unit operating in a web page and a web browser is embodied itself, since the script operating unit itself requests SetTimer and KillTimer, a web page requesting SetTimer and KillTimer may be recognized although web pages operate in the same thread. However, since the ActiveX control itself requests SetTimer and KillTimer, a web page requesting SetTimer and KillTimer may not be recognized still. Thus, in all cases, the web pages may be configured to operate in the respective threads.

In addition, when a container including some of the active elements contained in the web page, that is, a web browser provides ITimer and a COM interface related to ITimer, if a timer is required, the some of the active elements contained in the web page requests the timer through the COM interface. A timer is generated when the web browser unit 237 provides the COM interface, and the some of the active elements contained in the web page requests the timer. The generated timer is managed like in the case where SetTimer and KillTimer are hooked. In this method, since the COM interface may recognize a container requesting the timer, a web page requesting the timer may be recognized. Since the some of the active elements uses this method, this method may not be used in a wide scope. However, since a flash ActiveX control that significantly affects the performance related to the timer requests the timer by using this method, this method is sufficient to replace a method of requesting SetTimer and KillTimer when the method of requesting SetTimer and KillTimer cannot be used.

In addition to the above-described methods of controlling elements based on the timer, when the web browser, the ActiveX control, the scrip operating unit or script itself provides an interface for stopping and reproducing an operation, the operation may be stopped and reproduced using the interface.

All operating units are controlled so as not to perform a predetermined number of operations or more using a CPU at a predetermined point of time, by performing the operations using a synchronization object on an OS throughout the web browsing environment server 200. An example of the synchronization object may include semaphore. The operations to be controlled may mainly use a CPU. Examples of the operations may include an operation including capturing a web browser image, changing the web browser image by reducing the number of colors or according to the resolution of the user device 100, and then comparing the web browser image with a previous image in order to select and transmit different portions of the web browser image from the previous image, an operation in which a flash ActiveX control renders an image for each respective timer event, and an operation performed by the active elements contained in web pages by using a script operating unit for each respective timer event. When a plurality of processes of operating units are performed in a single web browsing environment server 200, and therefore a plurality of web pages operate, threads of the processes compete with each other in order to obtain a CPU usage time on the OS while performing operations using a large portion of the CPU. Thus, the OS assigns the CPU usage time to each thread by using a preemptive multitasking method. When excessively many threads compete with each other, since the CPU is taken away from a corresponding thread although the thread dose not complete an operation using the CPU, the thread needs to wait in order to receive the CPU again. Thus, since many operations are required in order for the OS to assign the CPU to each thread, that is, in order to achieve a task change, compared to a period of time for which the thread actually uses the CPU, the many operations are not negligible for reducing the performance of the web browsing environment server 200. At this time, by controlling all operating units so as not to simultaneously perform a predetermined number of operations or more, threads may ensure a period of time for completing their respective operations. Thus, the number of operations for the task change is reduced, thereby saving on the resources related to the performance of the web browsing environment server 200. The number of the operations of the operating units may be the same the number of CPUs contained in the web browsing environment server 200. Since an operation performed by the ActiveX control and scripts contained in the web page by using the timer event is less important than an operation of capturing and transmitting a web browser image, the operation of capturing and transmitting of the web browser image may be more smoothly performed by separately managing the two operations.

For example, the web browsing environment server 200 including 4 CPUs may be configured so as to simultaneously perform three operations of capturing and transmitting of the web browser image and to simultaneously perform only one operation performed by the ActiveX control and scripts. The control of the operations by using the timer event may be changed according to whether the timer event is set to be related to the window when SetTimer API is used, or the timer is set to call call-back without the window. First, when the timer event is set to be related to the window, if a WM_TIMER message is discovered in a repeated section in which a window message is dispatched, a corresponding WM_TIMER event is dispatched in a corresponding window or a call-back function is called when the synchronization object is obtained. When the timer is set to call-back without the window, call-back provided by the performance controlling unit 235 instead of original call-back is provided to the OS during hooking SetTimer, and then the original call-back is called while obtaining the synchronization object when the OS calls the call-back provided by the performance controlling unit 235.

In addition, when the web browser is embodied itself, resources related to the OS may be saved by restricting the number of sockets used for web browser units 237 to download a web page in a single web browsing environment server 200 through the synchronization object.

The user device 100 shows the user interface 110 to a user. When a desired operation is selected, the operation is transmitted to the web browsing environment server 200, and then is performed in the web browsing environment server 200. A state changed according to a result of the operation or a state that is automatically changed in a web browsing environment, and the web page image are transmitted from the web browsing environment server 200, and are reflected to the user interface 110.

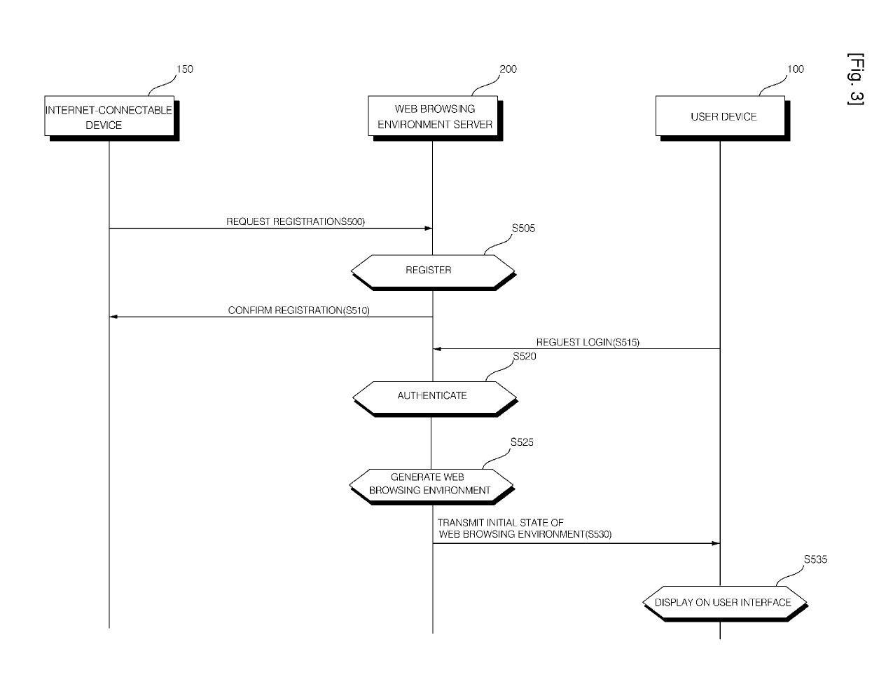

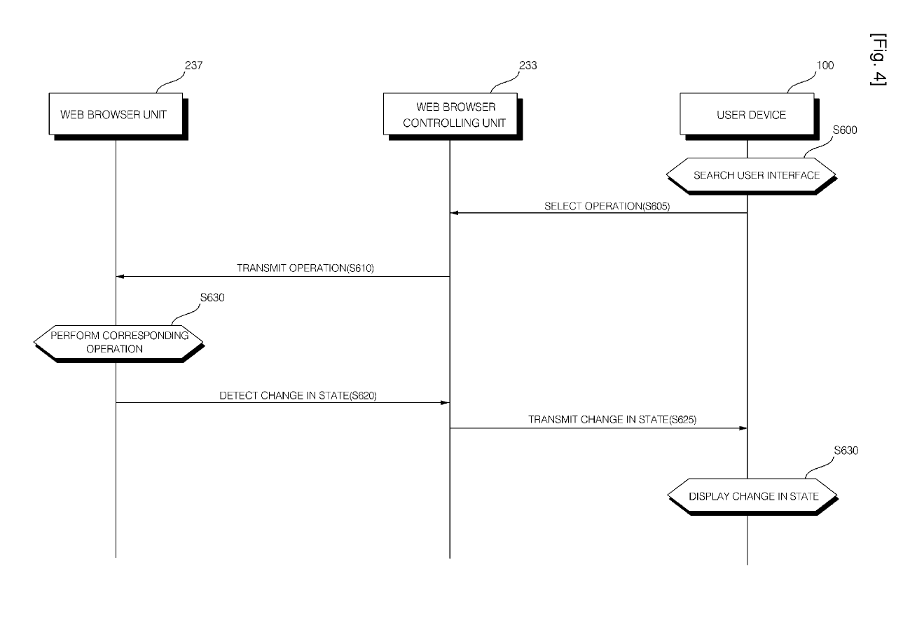

FIGS. 3 and 4 are message sequence charts for explaining a method of controlling a web browsing environment provider system for multiple users, according to an embodiment of the present invention.

FIG. 3 is a message sequence chart for explaining initialization included in an operation of web browsing environment provider system for multiple users, in which a remote server computer is used, according to an embodiment of the present invention. Referring to FIG. 3, a user requests the web browsing environment server 200 for registration for using a service via the user device 100 or an Internet-connectable device 150 (S500), the registration is completed (S505), the registration is confirmed (S510), and then the user downloads a program for providing the user interface 110 when the program is not installed in to the user device 100.

Next, the user requests login for using a web browsing environment in the user device 100 (S515), the web browsing environment server 200 performs user authentication (S520), the web browsing environment for the user is generated (S525), and then an initial state of the web browsing environment is transmitted (S530). The user device 100 displays the transmitted initial state of the web browsing environment together with a menu on a user interface (S535).

FIG. 4 is a message sequence chart for explaining a method including selecting an operation of the user device 100 and transmitting an actual operation and result thereof of the web browser unit 237, included in an operation of web browsing environment provider system for multiple users, according to an embodiment of the present invention. Referring to FIG. 4, the user device 100 searches the user interface 110 displayed on a screen (S600), selects a necessary function, and then a corresponding operation is transmitted to the web browsing environment server 200 (S605).

The web browser controlling unit 233 of the web browsing environment server 200 transmits an operation requested by the user device 100 to the web browser unit 237 (S610). At this time, the operation is transmitted by calling an interface function of a web browser control included in the web browser unit 237, transmitting a window message via the independent environment constructing unit 231, or performing keyboard and mouse simulations. The web browser unit 237 performs the transmitted operation (S515). At this time, the performance of the web browser unit 237 may be controlled by the performance controlling unit 235. When the web browser controlling unit 233 detects a change in a state of the web browser unit 237 (S520), information regarding the change in the state is transmitted to the user device 100.

The user device 100 receiving the information displays the information on the user interface 110 (S535).

In FIG. 4, the sate of the web browser unit 237 is changed by selecting an operation of the user device 100. Alternatively, the state of the web browser unit 237 may be changed without selecting the operation of the user device 100. In this case, the web browser controlling unit 233 detects and transmits the change in the state of the web browser unit 237 to the user device 100, like in FIG. 4. In addition, when the web browser controlling unit 233 does not recognize a change of an image of the web browser unit 237 due to the configuration of an environment of the web browser controlling unit 233, the web browser controlling unit 233 may detect a changed portions by comparing the current image with a previous image at a predetermined period, and may transmit a result of the detection to the user device 100.

Accordingly, multiple users can perform the same level of web browsing operation as in a PC that is a main device of web browsing by using a user device having lower performance than the PC or low compatibility with the PC.

In a web browsing environment provider system according to the present invention, since the web browsing environment server 200 performs a web browsing operation in which a web page is received and a response to the web page is transmitted to the web server 300, the web browsing environment server 200 needs to contain information required to perform the web browsing operation. At this time, when the information is user s personal information, a security function is required.

To obtain the security function, the user device 100 and the web server 300 may be connected using a virtual security connection. At this time, the virtual security connection includes two connections. One of these is a connection between first virtual connecting units that are installed in the user device 100 and the web browsing environment server 200, respectively. Another one of theses is a connection between a first virtual connecting unit installed in the web browsing environment server 200 and a second virtual connecting unit installed in the web server 300. The first virtual connecting unit installed in the web browsing environment server 200 may be included in the operating unit 230.

The virtual security connection may be embodied by adding data of a virtual connection into a data packet transmitted via a connection for a general web browsing like a packet layer structure of a conventional network system. The user device 100 and the web browsing environment server 200 may check the kind of a packet, may determine whether the packet is for the general web browsing or for virtual connection with the user device 100, and then may transmit a corresponding data packet according to a result of determination.

Accordingly, the first virtual connecting unit installed in the web browsing environment server 200 does not connect the user device 100 and the web browsing environment server 200 by directly using a general network system. Instead, the first virtual connecting unit installed in the web browsing environment server 200 receives connecting information via the connecting unit 210 of the web browsing environment server 200 recognizing and processing the above-described special situations. Then, the first virtual connecting unit installed in the web browsing environment server 200 functions as a software gateway transmitting data transmitted from a predetermined connection to an opposite connection while managing the two connections between the user device 100 and the web browsing environment server 200. Thus, the virtual connection between the user device 100 and the web server 300 is obtained, and a general end-to-end security connection is initialized in the virtual connection, thereby obtaining the virtual security connection between the user device 100 and the web server 300.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner.

While the present invention has been particularly displayed and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, multiple users can perform the same level of web browsing operation as in a personal computer (PC) that is a main device of web browsing by using a user device having lower performance than the PC or low compatibility with the PC.

1. A web browsing environment provider system for multiple users, the system comprising:
at least one user device on which a user interface is displayed for reading a web page and controlling web browsing; and
a web browsing environment server connected to the user device through a network, generating and managing an independent web browsing environment for each respective user device, notifying the user device about a state of the independent web browsing environment, rendering a web page, executing active contents contained in the web page, transmitting a web page image that is rendered to the user device, and controlling an operation requested by the user device to operate in the web browsing environment.

2. The system of claim 1, wherein the web browsing environment server controls a web browsing operation so as to save on resources by using at least one methods from among a method of reducing a number of web page rendering operations, a method of selectively stopping active elements contained in the web page, and a method of controlling a number of simultaneous operations related to the web browsing.

3. The system of claim 1, wherein the web browsing environment server uses an operating system (OS) compatible with windows, and
wherein, when an independent web browsing environment is generated for each respective user, the web browsing environment server uses a single OS user account that is already logged-on when a service starts device, and provides a common windows desktop image to all user devices.

4. The system of claim 3, wherein the web browsing environment server comprises:
a managing database storing and managing information for user authentication with respect to the user device; and
a connecting unit controlling an operation of the managing database.

5. The system of claim 3, wherein the web browsing environment server further comprises an operating unit providing web browsing to a user device connected via the connecting unit.

6. The system of claim 5, wherein the operating unit is contained in a web page downloaded from a web server, and interacts with the user device after the web page is downloaded so as to be connected to the user device, and, after the operating unit is connected to the web server, the operation unit transmits data transmitted from a predetermined connection to an opposite connection between the user device and the web server so as to provide a virtual connection between the user device and the web server.

7. The system of claim 5, wherein the operating unit comprises:
a web browser unit rendering and controlling a web page;
a web browser controlling unit receiving a command issued by the user device to control the web browser unit, and transmitting a result of detecting a change in a state of the web browser unit and a web page image rendered by the web browser unit to the user device;
an independent environment constructing unit constructing a web browsing environment independent for each respective user device; and
a performance controlling unit controlling a web browsing operation to save on resources related to performance.

8. The system of claim 7, wherein the operating unit performs a separate process for each respective user device on a common windows desktop image of the signal account, shares a single image, and shares a keyboard and a mouse.

9. The system of claim 8, wherein the independent environment constructing unit hooks a main windows API and performs a process on a process-by-process basis of the operating unit, generates a predetermined window message, and changes internal information according to contents of the window message when the window message is dispatched so that a user recognizes as if the operating unit has independent mouse and keyboard on a process-by-process basis of the operating unit.

10. The system of claim 9, wherein, when the web browser controlling unit captures an image of a web browser unit, the web browser controlling unit renders the image in an internal buffer by using a related windows API with respect to a separate web browser and a window related thereto, instead of capturing an actual windows desktop image so that the image is captured without displaying the image on an actual screen.

11. The system of claim 10, wherein cookies and temporary Internet files are managed for each respective user by a method in which the operating unit sets an OS environment variable related to a user folder for each respective user device, or a method in which the independent environment constructing unit hooks a windows API related to reading and storing operations of files and processes the reading and storing operations, so that each user device contains a web browsing environment independent from another user.

12. The system of claim 1, wherein the user interface comprises at least one of a web page image provided by the web browsing environment server, a menu for controlling web browsing, and a common menu for controlling an entire web browsing environment.

13. A method of controlling a web browsing environment provider system for multiple users, wherein the system comprises at least one user device connected and a web browsing environment server, which are connected via a network and communicates with each other, the method comprising:
generating a web browsing environment for each respective user device to the web browsing environment server;
displaying a user interface for the web browsing environment on the user device, searching the user interface on the user device, and transmitting a function item selected by searching the user interface to the web browsing environment server;
controlling a web browser unit in the web browsing environment server so that an operation corresponding to the selected function item is performed, wherein the web browser unit performs the selected function item; and
detecting a change in a state of the web browser unit and notifying the user device about information regarding the detected changed through a network.

14. The method of claim 13, further comprising:
requesting the web browsing environment server for authentication, wherein the requesting is performed by the user device; and
receiving a response to the authentication.

15. The method of claim 13, further comprising positioning a web browser window on a windows desktop, and then completely hiding a space above the web browser window with an empty window, so as to prevent window contents from being automatically rendered although a web browser and ActiveX controls are not needed.

16. The method of claim 13, further comprising: capturing an image without displaying the image on an actual screen by rendering the image in an internal buffer by using a related windows API with respect to a separate web browser and a window related to the separate web browser, when a web page image is captured; and
rendering widow contents only at a point of time when image contents are transmitted to the user device, wherein the rendering is performed by a web browser and ActiveX controls.

17. The method of claim 13, further comprising stopping active elements contained in a corresponding web page to save on resources related to performance, when a user device receives no input for a predetermined period of time, or a previous web page image is not displayed due to a configuration of the user interface while generating a new web page or converting a web page.

18. The method of claim 17, further comprising performing the active elements contained in the web page again, when the user device receives an input again, or the web page image is displayed again.

19. The method of claim 17, wherein the active elements are stopped by hooking SetTimer and KillTimer windows API to selectively stop and reproduce timers registered by the active elements contained in the web page, or by using an interface when a web browser, an ActiveX control, a script executor, or a script itself provides the interface.

20. The method of claim 19, wherein the timers are selectively stopped and reproduced by at least one of methods comprising; a method of dividing the timer on a thread-by-thread basis, wherein a thread is managed for each respective web page; a method of managing the timer for each respective web page when a web browser embodied itself and a script executor operating in the web page request the timer; and a method in which a web browser provides ITimer and a COM interface related to ITimer and the active elements requesting the timer is divided by using the COM interface in the web page.

21. The method of claim 13, further comprising: controlling the web browsing environment server to perform processes only when a synchronization object is obtained, by using the synchronization object on an operation system (OS) throughout the web browsing environment server.
